(19) United States
(12) Patent Application Publication
(10) Pub. No.: US 2024/0300626 A1
(43) Pub. Date: Sep. 12, 2024

(54) SYSTEMS AND METHODS FOR GENERATING A PHASE-RESOLVED OCEAN WAVE FORECAST WITH SIMULTANEOUS OCEAN CURRENT ESTIMATION USING DATA ASSIMILATION

(71) Applicant: THE REGENTS OF THE UNIVERSITY OF MICHIGAN, Ann Arbor, MI (US)

(72) Inventors: Yulin Pan, Ann Arbor, MI (US); Guangyao Wang, Tianjin (CN); Yuminghao Xiao, Wuhan (CN)

(21) Appl. No.: 18/180,688

(22) Filed: Mar. 8, 2023

(51) Int. Cl. B63B 43/02; B63B 51/00

(52) U.S. Cl. CPC B63B 43/02; B63B 51/00; G01C 13/002

(57) ABSTRACT

Systems and methods for generating a phase-resolved ocean wave forecast with ensemble based data assimilation are disclosed. An example method includes receiving radar data corresponding to an ocean surface, and determining a surface elevation, a surface potential, and an ocean current field of a portion of the ocean surface. The example method also includes generating an ensemble of perturbed ocean surface data, and applying a phase-resolved nonlinear wave model to the ensemble of perturbed ocean surface data to generate forecast ocean surface data. The example method also includes receiving a subsequent set of radar data corresponding to the ocean surface, and applying an ensemble Kalman filter to determine, a subsequent surface elevation, a subsequent surface potential, and a subsequent ocean current field. The example method also includes generating a phase-resolved ocean wave forecast based on iteratively analyzing the subsequent ocean field until a tolerance factor satisfies a tolerance threshold.

### FIELD OF THE DISCLOSURE

The present disclosure relates generally to techniques for modeling ocean waves and, more particularly, to systems and methods for generating a phase-resolved ocean wave forecast with simultaneous ocean current estimation using data assimilation.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Accurate prediction of ocean waves plays a significant role in the industries of shipping, oil & gas, aquaculture, ocean renewable energy, and coastal and offshore construction, in that the predictions inform decisions such as route planning, emergency procedures, and the like. In the past few decades, phase-averaged and phase-resolved wave models have been developed as a way to effectively predict such ocean waves. In particular, conventional phase-averaged wave models, which provide statistical descriptions in terms of the wave spectrum, have been widely adopted for the operational forecast of global and regional sea states. However, despite their widespread application, conventional phase-averaged models have limitations of providing no information on individual deterministic waves. For example, rogue waves, which often appear sporadically and potentially cause enormous damages to offshore structures and ships, cannot be predicted.

The problem is particularly acute because conventional phase-resolved models also struggle to provide accurate information on individual waves, partly due to the difficulty in obtaining the phase-resolved ocean surface as initial conditions. Regardless, in the unlikely event that these initial conditions are obtained, conventional linear or nonlinear phase-resolved wave models still struggle to efficiently predict individual waves over a sufficiently long prediction horizon. Conventional linear models are computationally efficient, but suffer from a severely limited prediction horizon, rendering them less than ideal as a practical solution for predicting individual waves. Conventional nonlinear models generally suffer from high computational costs as a result of requiring numerical integration of the Euler equations governing the evolution of the ocean free surface, but are otherwise more accurate than conventional linear models and have a relatively long prediction horizon if an accurate initial condition for the prediction can be provided. As a result, conventional phase-resolved models are ignored for individual wave prediction because both the linear and nonlinear models are impracticable.

Additionally, conventional techniques suffer from inaccuracies resulting from excluding and/or otherwise ignoring certain physical effects that may influence wave generation and evolution. Such physical effects may include ocean currents that are not known a priori, and are therefore not accurately accounted for in conventional, nonlinear models. Ignorance of these physical effects can substantially impact the resulting ocean wave forecast, but obtaining data of these effects can also prove challenging for conventional techniques. Global marine weather forecasts may provide measurements of ocean currents, wind field, etc., but these measurements are typically only available at a very coarse level of granularity at sparse time instances. Accordingly, directly interpolating the physical parameters from these measurements may result in significant errors that may ultimately lose the spatial-temporal variation of the current/wind fields on scales similar to the wave forecast domain and/or the time horizon. Other techniques for obtaining these parameters, such as fitting a current-modified dispersion relation resolved by the spatial-temporal spectrum of the wave field, ignore the nonlinearity of the prediction and generally requires dense measurements in both space and time that are typically impractical using only buoy data.

Therefore, there is a need for techniques capable of accurately and efficiently generating a phase-resolved ocean wave forecast with an accurate estimation of ocean current to enable long-term forecasting of ocean surfaces.

### SUMMARY OF THE INVENTION

According to an aspect of the present disclosure, a method for generating a phase-resolved ocean wave forecast with simultaneous ocean current estimation using data assimilation is disclosed herein. The method may comprise: (a) receiving, at one or more processors, a set of radar data corresponding to an ocean surface; (b) determining, by the one or more processors based on the set of radar data, a surface elevation, a surface potential, and an initial ocean current field of a portion of the ocean surface; (c) generating, by the one or more processors, an ensemble of perturbed ocean surface data based on the surface elevation, the surface potential, and the initial ocean current field; (d) applying, by the one or more processors, a phase-resolved nonlinear wave model to the ensemble of perturbed ocean surface data to generate a set of forecast ocean surface data; (e) receiving, at the one or more processors, a subsequent set of radar data corresponding to the ocean surface; (f) determining, by the one or more processors applying an ensemble Kalman filter, a subsequent surface elevation, a subsequent surface potential, and a subsequent ocean current field of the portion of the ocean surface based on the subsequent set of radar data; and (g) iteratively performing, by the one or more processors, steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

In a variation of this embodiment, the method further comprises: identifying, by the one or more processors, a rogue wave based on the phase-resolved ocean wave forecast; and generating, by the one or more processors applying a modified route planner, a modified travel route for a ship to avoid the rogue wave.

In another variation of this embodiment, the method further comprises: iteratively performing, by the one or more processors, steps (e)-(g) for the portion of the ocean surface until the portion is not included in the subsequent set of radar data.

In yet another variation of this embodiment, the set of radar data includes radar data corresponding to a plurality of points across a region of the ocean surface, the portion of the ocean surface corresponds to a respective point of the plurality of points, and the method further comprises: performing, by the one or more processors, steps (b)-(g) for each respective point of the plurality of points.

In still another variation of this embodiment, the method further comprises: linearly inflating, by the one or more processors utilizing an adaptive inflation algorithm, the set of forecast ocean surface data.

In yet another variation of this embodiment, the method further comprises: identifying, by the one or more processors, a first predictable zone and a first unpredictable zone within the set of radar data; identifying, by the one or more processors, a second predictable zone and a second unpredictable zone within the subsequent set of radar data; and iteratively performing steps (d) and (f) to generate the phase-resolved ocean wave forecast based on radar data from the set of radar data corresponding to an overlap region between the first predictable zone and the second predictable zone.

In still another variation of this embodiment, the phase-resolved nonlinear model comprises a high-order spectral (HOS) method.

In yet another variation of this embodiment, the ensemble of perturbed ocean surface data includes a plurality of surface elevations, a plurality of surface potentials, and a plurality of initial ocean currents, and the method further comprises: generating, by the one or more processors utilizing a set of measurement error statistics, the ensemble of perturbed ocean surface data based on the plurality of surface elevations, the plurality of surface potentials, and the plurality of initial ocean currents.

In still another variation of this embodiment, the method further comprises: causing, by the one or more processors, a user device to display the phase-resolved ocean wave forecast and the subsequent ocean current field on a user interface of the user device for viewing by a user.

In another embodiment, a system for generating a phase-resolved ocean wave forecast with simultaneous ocean current estimation using data assimilation is disclosed herein. The system may comprise: a memory storing a set of computer-readable instructions comprising at least a phase-resolved nonlinear wave model and an ensemble Kalman filter; and one or more processors interfacing with the memory, and configured to execute the set of computer-readable instructions to cause the one or more processors to: (a) receive a set of radar data corresponding to an ocean surface, (b) determine, based on the set of radar data, a surface elevation, a surface potential, and an initial ocean current field of a portion of the ocean surface, (c) generate an ensemble of perturbed ocean surface data based on the surface elevation, the surface potential, and the initial ocean current field, (d) apply a phase-resolved nonlinear wave model to the ensemble of perturbed ocean surface data to generate a set of forecast ocean surface data, (e) receive a subsequent set of radar data corresponding to the ocean surface, (f) determine, by applying an ensemble Kalman filter, a subsequent surface elevation, a subsequent surface potential, and a subsequent ocean current field of the portion of the ocean surface based on the subsequent set of radar data, and (g) iteratively perform steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

In a variation of this embodiment, the set of computer-readable instructions further cause the one or more processors to: identify a rogue wave based on the phase-resolved ocean wave forecast; and apply a modified route planner to generate a modified travel route for a ship to avoid the rogue wave.

In another variation of this embodiment, the set of computer-readable instructions further cause the one or more processors to: iteratively perform (e)-(g) for the portion of the ocean surface until the portion is not included in the subsequent set of radar data.

In yet another variation of this embodiment, the set of radar data includes radar data corresponding to a plurality of points across a region of the ocean surface, the portion of the ocean surface corresponds to a respective point of the plurality of points, and the set of computer-readable instructions further cause the one or more processors to: perform (b)-(g) for each respective point of the plurality of points.

In still another variation of this embodiment, the set of radar data is collected by a plurality of ships and a plurality of buildings.

In yet another variation of this embodiment, the ensemble of perturbed ocean surface data includes a plurality of surface elevations, a plurality of surface potentials, and a plurality of initial ocean currents, and the set of computer-readable instructions further cause the one or more processors to: generate, by utilizing a set of measurement error statistics, the ensemble of perturbed ocean surface data based on the plurality of surface elevations, the plurality of surface potentials, and the plurality of initial ocean currents.

In still another variation of this embodiment, the system further comprises a user interface, and the set of computer-readable instructions further cause the one or more processors to: cause the user interface to display the phase-resolved ocean wave forecast and the subsequent ocean current field for viewing by a user.

In yet another embodiment, a non-transitory computer-readable storage medium having stored thereon a set of instructions, executable by at least one processor, for generating a phase-resolved ocean wave forecast with simultaneous ocean current estimation using data assimilation is disclosed herein. The instructions may comprise: (a) instructions for receiving a set of radar data corresponding to an ocean surface; (b) instructions for determining, based on the set of radar data, a surface elevation, a surface potential, and an initial ocean current field of a portion of the ocean surface; (c) instructions for generating an ensemble of perturbed ocean surface data based on the surface elevation, the surface potential, and the initial ocean current field; (d) instructions for applying a phase-resolved nonlinear wave model to the ensemble of perturbed ocean surface data to generate a set of forecast ocean surface data; (e) instructions for receiving a subsequent set of radar data corresponding to the ocean surface; (f) instructions for determining, by applying an ensemble Kalman filter, a subsequent surface elevation, a subsequent surface potential, and a subsequent ocean current field of the portion of the ocean surface based on the subsequent set of radar data; and (g) instructions for iteratively performing steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

In a variation of this embodiment, the instructions further comprise: instructions for identifying a rogue wave based on the phase-resolved ocean wave forecast; and instructions for applying a modified route planner to generate a modified travel route for a ship to avoid the rogue wave.

In another variation of this embodiment, the instructions further comprise: instructions for iteratively performing (e)-(g) for the portion of the ocean surface until the portion is not included in the subsequent set of radar data.

In yet another variation of this embodiment, the set of radar data includes radar data corresponding to a plurality of points across a region of the ocean surface, the portion of the ocean surface corresponds to a respective point of the plurality of points, and the instructions further comprise: instructions for performing (b)-(g) for each respective point of the plurality of points.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A illustrates an example environment and on-board radar system for generating a phase-resolved ocean wave forecast with simultaneous ocean current estimation using data assimilation, in accordance various aspects disclosed herein.

FIG. 1B illustrates an example system including components of the on-board radar system of FIG. 1A, and in accordance various aspects disclosed herein.

FIG. 2A illustrates an example data workflow, as utilized by the example system of FIG. 1B, and in accordance with various aspects disclosed herein.

FIG. 2B is a schematic illustration of the data analysis performed in the example data workflow of FIG. 2A, and in accordance with various aspects disclosed herein.

FIG. 3A illustrates an example route planning problem scenario analyzed by the example system of FIG. 1B, in accordance with various aspects disclosed herein.

FIG. 3B illustrates an example route planning scenario performed by the example system of FIG. 1B when an obstacle is identified that may intercept a path of the vessel containing the example system of FIG. 1B, and in accordance with various aspects disclosed herein.

FIG. 4 illustrates an example method for generating a phase-resolved ocean wave forecast with simultaneous ocean current estimation using data assimilation, in accordance various aspects disclosed herein.

FIG. 5 depicts an example user interface display enabling a user to view a modified travel route to avoid an identified obstacle, in accordance with various aspects disclosed herein.

### DETAILED DESCRIPTION

As previously mentioned, conventional nonlinear models generally suffer from high computational costs as a result of requiring numerical integration of the Euler equations governing the evolution of the ocean free surface. To reduce the time involved in such numerical integration, the high-order spectral (HOS) method, which provides an efficient spectral solution to a boundary value problem involved in the nonlinear wave equations of nonlinear models, may be incorporated into nonlinear models. However, due to the significant uncertainties involved in the realistic forecast (e.g., imperfect initial free surface due to measurement and reconstruction errors; inaccurate accounting for wind, current, and other effects), as well as the chaotic nature of the nonlinear evolution equations, simulations generated by nonlinear models with HOS integration tend to deviate quickly from the true wave dynamics.

The techniques of the present disclosure solve these issues associated with nonlinear models, and more particularly, nonlinear models utilizing HOS method numerical integration, by including data assimilation (DA) to link the nonlinear model to reality through consistent model state updates with measurement data. Mathematically, the principle of DA is to minimize the error of analysis (i.e., results after combining model and measurements), or in a Bayesian framework, to minimize the variance of the state posterior given the measurements. Generally speaking, two categories of DA algorithms exist—variational-based approaches and Kalman-filter-based approaches. Variational-based algorithms are not directly applicable to operational forecasting due to their requirement of future data far after the analysis state (e.g., in contrast to the realistic situation where data becomes available sequentially in time). However, the Kalman-filter-based algorithms allow data to be sequentially assimilated by updating the present state as a weighted average of prediction values and measurement data, according to error statistics.

Thus, the present techniques provide sequential DA capabilities for nonlinear wave models by coupling an ensemble Kalman filter (EnKF) with HOS. As a result, the systems and methods of the present disclosure enable long-term forecasting of the ocean surface and current fields while ensuring minimized analysis error in a manner that was previously unachievable using conventional techniques. Moreover, the present techniques are intrinsically parallel, such that they may be implemented on processors (e.g., GPUs) in an offshore environment without sacrificing accuracy and/or efficiency in a manner that is similarly unattainable with conventional techniques. Further, the techniques of the present disclosure provide additional advantages of performing such ocean surface forecasting remotely. Conventional techniques typically require some form of craft present in the ocean or other body of water to measure ocean surface parameters (e.g., current, wave height, etc.), but the techniques of the present disclosure eliminate that requirement by providing accurate, timely estimations of the ocean surface using remote data.

Additionally, as described herein, the techniques of the present disclosure may include multiple data points related to the ocean surface (e.g., current fields), such that the models discussed herein may provide increasingly accurate results over time, unlike conventional techniques. As the models iteratively generate phase-resolved ocean forecasts using the variety of measured data relating to the ocean surface, the models may iteratively reduce the error associated with each predicted future state of the ocean surface. In other words, the ocean forecast generated by the models of the present application is directly affected by the measured parameters, such that this substantial parameterization contributes fundamental data that is crucial in understanding how the ocean surface may change over time, and thus, how rogue waves and other waves may form based on these parameters.

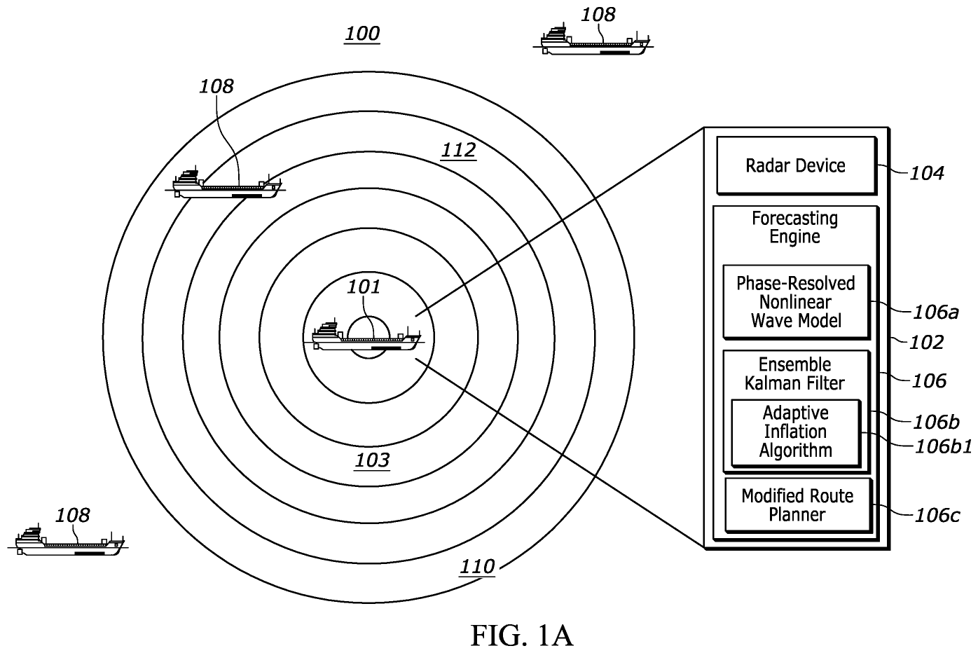

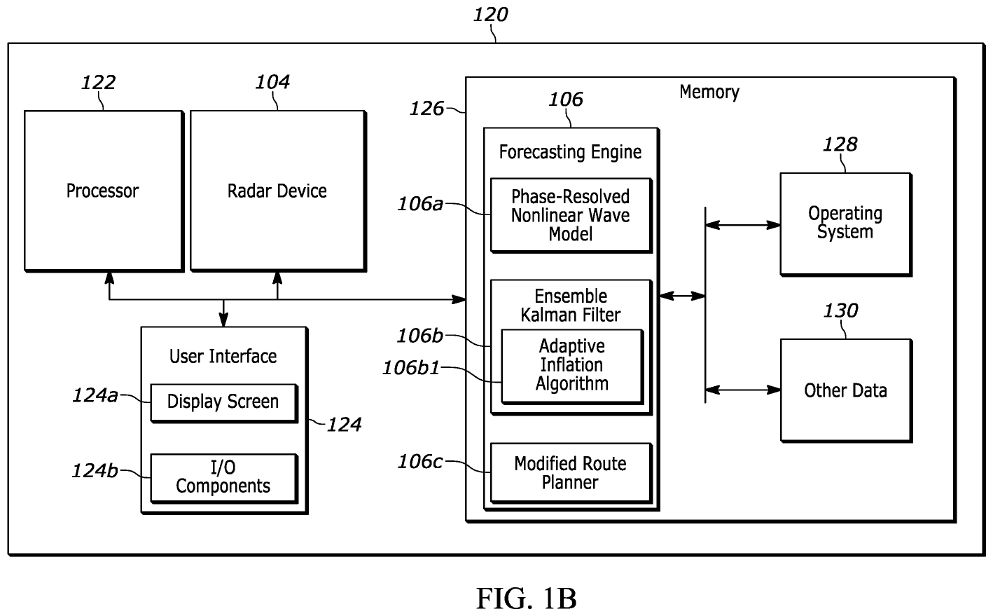

To provide a general understanding of the system(s)/components utilized in the techniques of the present disclosure, FIGS. 1A and 1B illustrate, respectively, an on-board radar system 102, and an example system 120 containing components of the on-board radar system 102 that are configured for generating a phase-resolved ocean wave forecast with simultaneous ocean current estimation using data assimilation. Accordingly, FIG. 1A provides a general overview of the on-board radar system 102 components, and FIG. 1B describes the components and their respective functions in greater detail. Moreover, it should be appreciated that the on-board radar system 102 may be incorporated as part of the example system 120, and/or the example system 120 may be the on-board radar system 102.

In any event, FIG. 1A illustrates an example environment 100 and an on-board radar system 102 for generating a phase-resolved ocean wave forecast with simultaneous ocean current estimation using data assimilation, in accordance various aspects disclosed herein. It should be appreciated that the example environment 100 an on-board radar system 102 are merely examples and that alternative or additional embodiments are envisioned.

In reference to FIG. 1A, the example environment 100 may be an ocean environment in which various vessels, structures, and/or other objects may be located. Generally, each vessel, structure, and/or other object may include a radar system in order to detect/track other objects within the vicinity and to monitor ocean surface conditions. If a vessel approaches another vessel or a structure too closely, or if the ocean surface in a particular area in which a vessel is traveling is too rough, the vessel and/or structure may detect such occurrences through the corresponding radar device. As a result, a vessel may move to avoid other vessels/structures/objects, and structures may proactively prepare for an imminent collision. Typically, though, the radar data may be used primarily to detect/track unfavorable ocean surface conditions, such that ocean-going vessels and/or structures may prepare accordingly.

As illustrated in FIG. 1A, the central ship 101 may include the on-board radar system 102, and may thereby produce a scanning radar pattern 103 to view the surrounding region of the ocean surface by utilizing the radar device 104. The scanning radar pattern 103 may correspond to the maximum scannable region of the radar device 104, which in certain aspects, may extend approximately 5 kilometers (km) radially away from the central ship 101. The overall length of travel routes (also referenced herein as “paths”) for ocean-going vessels may extend well beyond 5 km (e.g., 10s, 100s of km), so the prediction horizon for an average vessel is relatively limited, thereby elevating the importance of quick and accurate predictions. However, in certain aspects, the central ship 101 may receive radar data generated by additional ships (e.g., vessels 108), structures (e.g., structure 110), and/or any other suitable object or combinations thereof to extend the effective range of the scanning radar pattern 103, and by extension, the radar device 104.

In any event, and as discussed further herein, the radar device 104 may generate radar data that is sent to the forecasting engine 106, where the radar data is processed/interpreted by a phase-resolved nonlinear wave model 106a, an ensemble Kalman filter 106b, and an adaptive inflation algorithm 106b1 in order to output a phase-resolved ocean wave forecast. The phase-resolved ocean wave forecast may generally provide a user with ocean surface information, and more particularly, whether or not an obstacle exists within the scanning radar pattern 103 that may impact the travel of the central ship 101. In the event that an obstacle exists within the scanning radar pattern 103, and the forecasting engine 106 determines that the obstacle will likely impact the travel of the central ship 101, the modified route planner 106c may generate a modified travel route (also referenced herein as an “optimal path”) for the central ship 101 in order to avoid the obstacle, thereby reducing the risk of damage to the ship 101 and/or optimizing the energy (e.g., fuel) consumed in order to avoid the obstacle.

For example, the radar device 104 may generate radar data that is received by the forecasting engine 106, which may determine that a rogue wave 112 is present within the scanning radar pattern 103 of the radar deice 104. The forecasting engine 106 may compare the trajectory and speed of the rogue wave 112 to the current trajectory (e.g., a planned route) and speed of the central ship 101 to determine whether or not the rogue wave 112 will likely impact the travel of the central ship 101 by intercepting the current ship 101 at some point along the current trajectory of the central ship 101. If the forecasting engine 106 determines that the rogue wave 112 will likely intercept the current ship 101 at a particular point along the current trajectory of the ship 101, then the forecasting engine 106 (by the alternative route planner 106) may generate a modified travel route for the ship 101 in order to avoid the rogue wave 112 while still reaching the destination indicated by the planned route of the ship 101.

Of course, as previously mentioned, the central ship 101 may not perform processing actions sufficient to determine the trajectory and/or the speed of the rogue wave 112, as such processing may be performed remotely. In these circumstances, the remote processing may be performed by external servers and/or other suitable processing devices configured to receive ocean surface data in the form of radar data (e.g., surface elevation data, surface potential data, ocean current field data) and/or any other suitable data or combinations thereof.

In FIG. 1B, the example system 120 may be an integrated processing device of the central ship 101 and/or a remote processing device (e.g., server) that includes a processor 122, a user interface 124, the radar device 104, and a memory 126. The memory 126 may store the forecasting engine 106 that includes the phase-resolved nonlinear wave model 106a, the ensemble Kalman filter 106b, the adaptive inflation algorithm 106b1, and the modified route planner 106c, such that the example system 120 may include the components of the on-board radar system 102 in FIG. 1A. The memory 126 may also store an operating system 128 capable of facilitating the functionalities as discussed herein, as well as other data 130.

Generally, the processor 122 may interface with the memory 126 to access/execute the operating system 128, the other data 130, and the forecasting engine 106. The other data 130 may include a set of applications configured to facilitate the functionalities as discussed herein, and/or may include other relevant data, such as display formatting data, etc. For example, the processor 122 may access the operating system 128 in order to execute applications included as part of the other data 130, such as a vessel overview application (not shown) configured to facilitate functionalities associated with monitoring and adjusting parameters associated with a vessel (e.g., central ship 101) in which the example system 120 is incorporated, as discussed herein. As another example, the other data 130 may include operational data associated with the vessel (e.g., fuel level, engine temperature, etc.), and/or any other suitable data or combinations thereof. It should be appreciated that one or more other applications are envisioned. Moreover, it should be understood that any processor (e.g., processor 122), user interface (e.g., user interface 124), and/or memory (e.g., memory 126) referenced herein may include one or more processors, one or more user interfaces, and/or one or more memories.

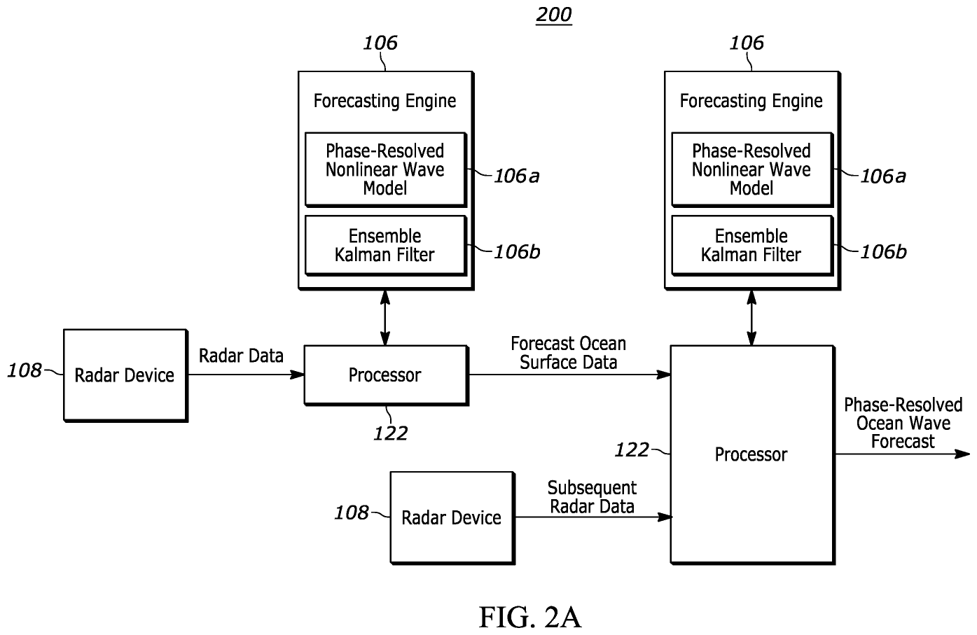

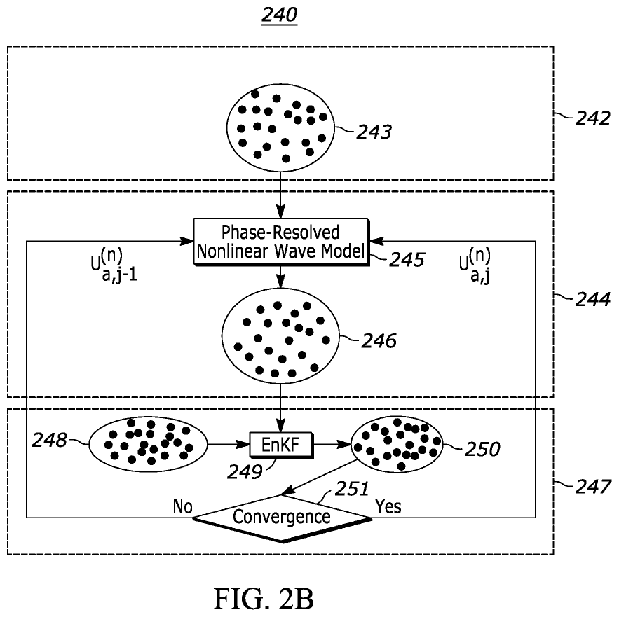

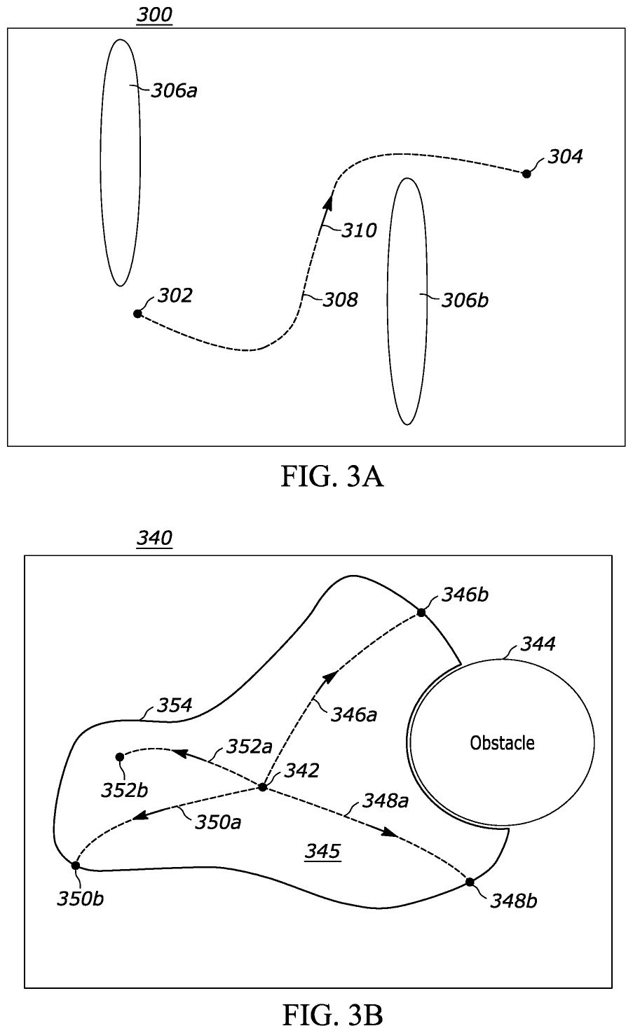

The processor 122 may access the memory 126 to execute the forecasting engine 106 in order to automatically analyze radar data received from the radar device 104, and as a result, generate a phase-resolved ocean wave forecast with simultaneous ocean current field estimation and/or a modified travel route. Thus, for ease of discussion, it should be understood that when referenced herein as the forecasting engine 106, the phase-resolved nonlinear wave model 106a, the ensemble Kalman filter 106b, the adaptive inflation algorithm 106b1, and/or the modified route planner 106c performing an action, the processor 122 may access and execute any of the instructions comprising the forecasting engine 106, the phase-resolved nonlinear wave model 106a, the ensemble Kalman filter 106b, the adaptive inflation algorithm 106b1, and/or the modified route planner 106c to perform the action. Moreover, reference to FIGS. 2A, 2B, 3A, and 3B may be made in order to help illustrate the concepts discussed herein.

The memory 126 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The example system 120 may further include a user interface 124 configured to present/receive information to/from a user. As shown in FIG. 1B, the user interface 124 may include a display screen 124a and I/O components 124b (e.g., ports, capacitive or resistive touch sensitive input panels, keys, buttons, lights, LEDs). According to some aspects, a user may access the example system 120 via the user interface 124 to review outputs from the forecasting engine 106, make various selections, and/or otherwise interact with the example system 120.

In some aspects, the example system 120 may perform the functionalities as discussed herein as part of a “cloud” network or may otherwise communicate with other hardware or software components within the cloud to send, retrieve, or otherwise analyze data. Thus, it should be appreciated that the example system 120 may be in the form of a distributed cluster of computers, servers, machines, or the like. In this implementation, a user may utilize the distributed example system 120 as part of an on-demand cloud computing platform. Accordingly, when the user interfaces with the example system 120 (e.g., by interacting with an input component of the I/O components 124b), the example system 120 may actually interface with one or more of a number of distributed computers, servers, machines, or the like, to facilitate the described functionalities.

In certain aspects, the example system 120 may communicate and interface with an external server (not shown) via a network(s). The external server may be associated with, for example, an entity that communicates radar data to various vessels/structures/objects and/or may otherwise disseminate information from the radar deice 104 and/or the forecasting engine 106, and may receive the radar data and/or outputs from the forecasting engine 106 from the example system 120. In particular, the external server may include or support a web server configured to host a website that enables users to view data received from the example system 120 for communicating to other vessels, analysis by the users, and/or for any other suitable purpose or combinations thereof. For example, the external server may enable a user to receive an indication of a rogue wave as well as a modified travel route for one or more vessels nearby the rogue wave from the example system 120 in order to enable the user to disseminate the information to connected vessels/structures/objects.

Further in these aspects, the network(s) used to connect the example system 120 to the external server may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). Moreover, the external server may include a memory as well as a processor, and the memory may store an operating system capable of facilitating the functionalities as discussed herein as well as the forecasting engine 106.

Additionally, it is to be appreciated that a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) 122 (e.g., working in connection with the operating system 128) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some aspects, the computer program product may be part of a cloud network of resources.

In any event, the radar device 104 may generate radar data, and may transmit the radar data to the forecasting engine 106 which analyzes the radar data to determine a surface elevation, a surface potential, and an ocean current field of a portion of the ocean surface. As illustrated in the example data workflow 200 of FIG. 2A, the radar device 108 transmits radar data to the processor 122, which may utilize/access the forecasting engine 106 to process the radar data, as described herein. For example, the portion of the ocean surface may correspond to the scannable area (e.g., scanning radar pattern 103) of the radar device 104 where the vessel containing the radar device 104 is located. As such, the forecasting engine 106 may determine surface elevations, surface potentials, and ocean current fields for the portion of the ocean surface by analyzing subsections of the portion of the ocean surface to determine an average surface elevation, an average surface potential, and an ocean current field for each subsection. Each subsection may be of any suitable dimensions (e.g., 0.1 km², 0.5 km², 1 km², etc.), and the dimensions may be determined based on the granularity of the radar data generated/transmitted by the radar device 104.

For ease of discussion, the surface elevations, surface potentials, and ocean current fields determined by the forecasting engine 106 (as well as the subsequent actions performed by the forecasting engine 106 and any components 106a, 106b, 106c) may be collectively referenced as corresponding to a single portion of the ocean surface for which the forecasting engine 106 receives radar data. However, it should be understood that the forecasting engine 106 may determine a surface elevation(s), a surface potential(s), and an ocean current field(s) for each portion of the ocean surface for which the forecasting engine 106 receives radar data.

When the forecasting engine 106 determines the surface elevation, the surface potential, and the ocean current field corresponding to the portion of the ocean surface, the engine 106 may proceed to generate an ensemble of perturbed ocean surface data 243 based on the surface elevation, the surface potential, and the ocean current field. For example, in the schematic illustration 240 of FIG. 2B, the forecasting engine 106 may utilize the radar data received from the radar device 104 at the initialization step 242 to generate an ensemble of perturbed ocean surface data 243.

In order to produce the ensemble members of the ensemble of perturbed ocean surface data 243, the forecasting engine 106 may produce the surface elevation η_{m,j}⁽ⁿ⁾ from:

$${η}_{m , j}^{( n )} ( x ) = {η}_{m , j} ( x ) + {ω}^{( n )} ( x ) , \qquad ( 1 )$$

where ω⁽ⁿ⁾(x) may be the random noise following a zero-mean Gaussian process, and x may generally correspond to the two-dimensional spatial coordinates of the portion of the ocean surface. The random noise may have a spatial correlation function given by:

$$C ( {ω}^{( n )} ( {x}_{1} ) , {ω}^{( n )} ( {x}_{2} ) ) = \{ \begin{matrix}c exp ( - \frac{\vert {x}_{1} - {x}_{2} {\vert}^{2}}{{a}^{2}} ) & for \vert {x}_{1} - {x}_{2} \vert \leq \sqrt{3} a , \\ 0 & for \vert {x}_{1} - {x}_{2} \vert > \sqrt{3} a\end{matrix} , \qquad ( 2 )$$

where c may be the variance of ω⁽ⁿ⁾(x), and a is the de-correlation length scale. In certain aspects, both c and a may depend on the characteristics of the measurement devices (e.g., radar device 104).

Thereafter, the forecasting engine 106 may utilize the principles embodied in equations (1) and (2) to reconstruct the surface potential ψ_{m,j}⁽ⁿ⁾ from the surface elevation η_{m,j}⁽ⁿ⁾ using linear wave theory. Namely, the forecasting engine 106 may approximate the surface potential ψ_{m,j}⁽ⁿ⁾ by integrating over a Fourier space representation of the surface elevation \tilde{η}_{m,j}⁽ⁿ⁾(k), as given by:

$${ψ}_{m , j}^{( n )} ( x ) ∼ \int \frac{i}{\sqrt{\vert k \vert}} {\tilde{η}}_{m , j}^{( n )} ( k ) {e}^{ik \cdot x} dk , \qquad ( 3 )$$

where \tilde{η}_{m,j}⁽ⁿ⁾(k) denotes a Fourier space representation of the n^{th} member of the perturbed surface elevation at vector wavenumber k, that is included in the ensemble of perturbed ocean surface data 243 generated by the forecasting engine 106. In equation (3), it should be appreciated that the surface potential ψ_{m,j}⁽ⁿ⁾ may only be approximated because the sign of the integrand relies on the wave traveling direction in addition to the complex conjugate relationship that must be satisfied for modes k and −k.

The forecasting engine 106 may also generate the ensemble ocean current field by starting with an initial guess represented as:

U₀(x)≡(U_{x,0}(x),U_{y,0}(x)) (4),

which, in general, may not be identical to the real-world ocean current field U^{true}(x, t₀). Practically speaking, the forecasting engine 106 may set the initial ocean current field represented by equation (4) to zero and/or may retrieve an initial ocean current field from a large-scale marine weather forecast. Regardless, the forecasting engine may 106 may further generate the ensemble of the ocean current field by adding random-field perturbations u(x) to each component of the initial guess of equation (4). Such random-field perturbations may be given by:

U_{*,0}⁽ⁿ⁾(x)=U_{*,0}(x)+u(x) (5),

Where the subscript * denotes one of the variables x or y, and u(x) is a random field defined by equation (2) with u replacing w, such that the variance is represented by cᵤ and the decorrelation length scale is represented by aᵤ.

Accordingly, as a result of the forecasting engine 106 calculating each of the surface elevation, surface potential, and the ensemble ocean current field, the forecasting engine 106 may proceed at the forecasting step 244 to generate an ensemble of forecast ocean surface data (also referenced herein as a “set of forecast ocean surface data”). In particular, the phase-resolved nonlinear wave model 245 may analyze the ensemble of perturbed ocean surface data 243 to generate the set of forecast ocean surface data.

The phase-resolved nonlinear wave model 106a may solve the evolution of the wave and current augmented states from tⱼ to tⱼ₊₁ by utilizing the surface elevation, the surface potential, and the ocean current field corresponding to each member of the ensemble. More specifically, the phase-resolved nonlinear wave model 106a may solve the evolution of the wave and current augmented states by integrating a nonlinear wave equation under the effect of the current. For example, the nonlinear wave equations may be given by:

$$\frac{\partial η ( x , t )}{\partial t} + \frac{\partial ψ ( x , t )}{\partial x} \cdot \frac{\partial η ( x , t )}{\partial x} - [ 1 + \frac{\partial η ( x , t )}{\partial x} \cdot \frac{\partial η ( x , t )}{\partial x} ] {ϕ}_{z} ( x , t ) + \frac{\partial η ( x , t )}{\partial x} \cdot U ( x , {t}_{j} ) + η ( x , t ) \frac{\partial }{\partial x} \cdot U ( x , {t}_{j} ) = 0 , \qquad ( 6 )$$

$$\frac{d ψ ( x , t )}{\partial t} + \frac{1}{2} \frac{\partial ψ ( x , t )}{\partial x} \cdot \frac{\partial ψ ( x , t )}{\partial x} + η ( x , t ) - \frac{1}{2} [ 1 + \frac{\partial η ( x , t )}{\partial x} \cdot \frac{\partial η ( x , t )}{\partial x} ] {{ϕ}_{z} ( x , t )}^{2} + \frac{\partial ψ ( x , t )}{\partial x} \cdot U ( x , {t}_{j} ) = 0 , \qquad ( 7 )$$

and the phase-resolved nonlinear wave model 106a may also utilize a persistence model represented as:

$$\frac{\partial U ( x , t )}{\partial t} = 0 , \qquad ( 8 )$$

where ϕ_{z}(x, t)≡∂ϕ/∂z|_{z=n}(x, t) may represent the surface vertical velocity, such that ϕ(x, z, t) may be the velocity potential of the wave field, and ψ(x, t)=ϕ(x, η, t). Moreover, the U(x, tⱼ) in equations (6) and (7) may represent an estimated quantity of the ocean current field that takes the form U₀⁽ⁿ⁾(x) at t=t₀ or U_{a,j}⁽ⁿ⁾(x) at t=tⱼ.

Broadly, equations (6) and (7) may represent the evolution of a nonlinear wave field under the effect of an irrotational current that slowly varies in space. This set of equations (6) and (7) may form a Hamiltonian system conserving the total energy of the wave and the current. Consequently, the phase-resolved nonlinear wave model 245 may utilize equations (6) and (7) to relax the scale-separation assumptions and irrotational assumptions included therein in certain circumstances. Additionally, the persistence model represented by equation (8) may indicate that the ocean current field remains steady during the forecasting step 244 of the phase-resolved nonlinear wave model 245, such that U_{f,j+1}=U_{a,j}.

With these nonlinear wave equations (6), (7), and the persistence model (8), the phase-resolved nonlinear wave model 106a may proceed to determine the forecast ensemble 246, including the surface elevation, surface potential, and the ensemble ocean current field, as represented generally by equations (1), (3), and (4). As an example, the phase-resolved nonlinear wave model 106a may utilize a pseudo-spectral method in combination with a mode-coupling approach, and/or any other suitable methods or combinations thereof. Regardless, in general, the phase-resolved nonlinear wave model 106a may solve equations (6)-(8) by integrating them in time (e.g., from tⱼ₋₁ to tⱼ) for each ensemble member to generate the forecast ensemble 246 (also referenced herein as a “set of forecast ocean surface data”). For example, the phase-resolved nonlinear wave model 106a may generate the forecast ensemble 246, as represented by:

$${\{ {η}_{f , j}^{( n )} \}}_{n = 1}^{N} , {\{ {ψ}_{f , j}^{( n )} \}}_{n = 1}^{N} , {\{ {U}_{f , j}^{( n )} \}}_{n = 1}^{N} , \qquad ( 9 )$$

and may proceed to transmit the forecast ensemble 246 to the ensemble Kalman filter 249 for analysis at the analysis step 247.

In particular, at the analysis step 247, the ensemble Kalman filter 249 may combine the forecast ensemble 246, represented in equation (9), with a perturbed measurement ensemble 248. The perturbed measurement ensemble 248 may be and/or represent a subsequent set of radar data corresponding to the ocean surface that has been perturbed, similar to the perturbations described by equations (1), (3), and (4) to generate the ensemble of perturbed ocean surface data 243. These ensembles 246, 248 may have dimensionality defined as:

(η_{f,j}⁽ⁿ⁾∈ [symbol] ^{L},ψ_{f,j}⁽ⁿ⁾∈ [symbol] ^{L},U_{f,j}⁽ⁿ⁾∈ [symbol] ^{2L}) (10),

(η_{m,j}⁽ⁿ⁾∈ [symbol] ^{d},ψ_{m,j}⁽ⁿ⁾∈ [symbol] ^{d}) (11),

where L and d represent the dimensionality of the forecast space and measurement space, respectively. Additionally, f may indicate forecast data, and m may indicate measurement data.

At the analysis step 247, the forecasting engine 106 may utilize a covariance matrix, which may be defined by a covariance operator [symbol] represented as:

$$( x , y ) = - \overline{x} ) {( {y}^{( n )} - \overline{y} )}^{T} , \qquad ( 12 )$$

which produces the covariance matrix between two vectors x and y through an ensemble average, and x̅ and y̅ represent mean values of the ensemble. With the ensembles 246, 248 represented by equations (10) and (11) and the covariance operator represented by equation (12), the ensemble Kalman filter 249 may analyze the forecast ensemble 246 and perturbed measurement ensemble 248 to generate a phase-resolved ocean wave forecast 250 that includes a subsequent surface elevation, a subsequent surface potential, and a subsequent ocean current field. For example, the ensemble Kalman filter 249 may combine the forecast ensemble 246 with the perturbed measurement data 248 to produce analysis results represented by:

$${n}_{a , j}^{( n )} = {η}_{f , j}^{( n )} + {Q}_{ηη , j} {{G}^{T} ( {GQ}_{ηη , j} {G}^{T} + {R}_{ηη , j} )}^{- 1} ( {η}_{m , j}^{( n )} - G {η}_{f , j}^{( n )} ) , \qquad ( 13 )$$

$${ψ}_{a , j}^{( n )} = {ψ}_{f , j}^{( n )} + {Q}_{ψψ , j} {{G}^{T} ( {GQ}_{ψψ , j} {G}^{T} + {R}_{ψψ , j} )}^{- 1} ( {ψ}_{m , j}^{( n )} - G {ψ}_{f , j}^{( n )} ) , \qquad ( 14 )$$

$${U}_{a , j}^{( n )} = {U}_{f , j}^{( n )} + {Q}_{U η , j} {{G}^{T} ( {GQ}_{ηη , j} {G}^{T} + {R}_{ηη , j} )}^{- 1} ( {η}_{m , j}^{( n )} - G {η}_{f , j}^{( n )} ) , \qquad ( 15 )$$

$$where$$

$${Q}_{xy , j} = ( {x}_{f , j} , {y}_{f , j} ) , \qquad ( 16 )$$

$${R}_{xy , j} = ( {x}_{m , j} , {y}_{m , j} ) , \qquad ( 17 )$$

and G may be an operator that maps a state vector from the L-dimensional forecast/model space to the d-dimensional measurement space (i.e., [symbol] ^{L}→ [symbol] ^{d}). For example, the ensemble Kalman filter 249 may receive the forecasts ensemble 246 and the perturbed measurement data 248 to generate the analysis ensemble 250, which may represent a phase-resolved ocean wave forecast. However, as previously mentioned, the forecast ocean current field U_{f,j}⁽ⁿ⁾ may not represent the true, real-world ocean current field U^{true}(x, tⱼ) at the time tⱼ. While the analysis result ocean current field U_{a,j}⁽ⁿ⁾ may provide an updated ocean current field that is closer to the true, real-world ocean current field, the prior analysis step 247 may have been performed with an inaccurate ocean current field. Accordingly, if left unchecked, such inaccuracy may produce an inaccurate phase-resolved ocean wave forecast.

To alleviate issues associated with utilizing a potentially inaccurate ocean current field, and as illustrated in FIG. 2B, the forecast step 244 and the analysis step 247 may be iteratively performed to continually increase the accuracy of the forecast/analysis results. Thus, at block 251, the forecasting engine 106 may determine whether or not the forecast ocean current field U_{f,j}⁽ⁿ⁾ has converged to within a threshold amount of the analysis result ocean current field U_{a,j}⁽ⁿ⁾. In this context, convergence may be defined by:

$${‖ {\overline{U}}_{f , j} ( x ) - {\overline{U}}_{a , j} ( x ) ‖}_{2} < δ , \qquad ( 18 )$$

where delta is a convergence threshold. Thus, the forecasting engine 106 may iteratively perform the forecast step 244 and the analysis step 247 until convergence is achieved, as defined by equation (18), and/or until the forecasting engine 106 determines that the forecast step 244 and the analysis step 247 have been performed greater than a threshold number of times.

As illustrated in FIG. 2B, the forecasting engine 106 may analyze the convergence of the forecast/analysis ocean current fields at block 251, and may determine whether or not the ocean current fields have achieved convergence. If so (Yes branch of block 251), then the forecasting engine 106 may initialize a subsequent forecast step 244 that may utilize the analysis ensemble 250 as the inputs to the phase-resolved nonlinear wave model 245. If the ocean current fields have not achieved convergence (No branch of block 251), then the forecasting engine 106 may perform a forecast step 244 that includes the analysis results of the surface elevation η_{a,j}⁽ⁿ⁾ and surface potential ψ_{a,j}⁽ⁿ⁾, but uses the prior analysis result of the ocean current field U_{a,j-1}⁽ⁿ⁾. In this manner, the forecasting engine 106 may generate a highly accurate phase-resolved ocean wave forecast with simultaneous ocean current estimation at least by iteratively improving the accuracy of the ocean current field used to forecast the wave and current fields.

In any event, as the forecasting engine 106 continues to iteratively evaluate analysis results in accordance with the actions described herein regarding the forecast step 244 and the analysis step 247, the error associated with subsequent analysis results may be relatively smaller than the error associated with the prior analysis results due to the compounding effects of continually incorporating additional measurement data (e.g., 248) into the forecasts. Accordingly, with each subsequent iteration, the analysis error may continue to decrease, causing the resulting forecast to become increasingly accurate over time.

The forecasting engine 106 may complete the iterative analysis represented by equations (6)-(18) upon determining that the time instance of a particular iteration exceeds a maximum time threshold and/or based on any other suitable metric(s) or combinations thereof. When the forecasting engine 106 completes the iterative analysis, the engine 106 may output a phase-resolved ocean wave forecast. However, due to a finite ensemble size and certain underrepresented physics in the nonlinear wave equations (6) and (7), the ensemble Kalman filter 249 may generate statistical errors leading to filter divergence and a generally sub-optimal analysis of the ocean surface. Thus, the ensemble Kalman filter 249 may additionally apply an adaptive inflation algorithm (e.g., adaptive inflation algorithm 106b1) to each member of the forecast ensemble 246 during any suitable iteration(s) to alleviate these issues prior to performing the analysis step 247 to generate the phase-resolved ocean wave forecast. The adaptive inflation algorithm 106b1 may generally include linearly inflating each member of the forecast ensemble 246 according to:

$${s}_{f , j}^{( n ) , i n f} = \sqrt{{λ}_{j}} ( {s}_{f , j}^{( n )} - {\overline{s}}_{f , j} ) + {\overline{s}}_{f , j} , n = 1 , 2 , … N , \qquad ( 19 )$$

where s may generally represent the individual state variables from the collective ensemble indicated in equation (9), and λⱼ≥1 may be a covariance inflation factor, which the adaptive inflation algorithm 106b1 may determine at each t=tⱼ and which may generally be an additional state variable that maximizes a posterior distribution (p(λⱼ|η_{m,j})). Thereafter, the adaptive inflation algorithm 106b1 may apply a localization scheme by performing, for example, a Schur product between Q_{s,j} and a local-correlation function μ, represented by:

Q_{s,j}=μ°Q_{s,j} (20),

where μ may be defined, for example, as a Gaspari-Cohn function, or any other suitable function or combinations thereof.

Additionally, in certain aspects, the ensemble Kalman filter 106b and/or the phase-resolved nonlinear wave model 106a may automatically adjust the determinations described above in response to the movement of the vessel. Generally, the observable region surrounding the vessel (e.g., represented by the set of radar data defining the scanning radar pattern 103) may include a sub-region that constitutes a “predictable” zone where the wave field is computationally tractable given an observation of the field in a limited space at a particular instant in time. Consequently, the observable region may also include an unpredictable zone that is not computationally tractable based on the direction of travel of the vessel which may eliminate the regions of the observable region within the unpredictable zone when receiving subsequent radar data, thereby eliminating the possibility of applying equations (13)-(15) to the prior radar data from the unpredictable zone. However, the ensemble Kalman filter 106b and/or the phase-resolved nonlinear wave model 106a may adjust the calculations involved in generating the phase-resolved ocean wave forecast based on, for example, an overlap region between the predictable zone at a first time and the predictable zone at a second time (or any suitable number of iterations).

Depending on the wave travelling direction, the boundary of the spatial predictable zone may move in time between a maximum or a minimum group speed within all wave modes. Practically speaking, for a forecast from tⱼ₋₁ to tⱼ the predictable zone P(t) at t=tⱼ may constitute a sub-region of the computationally tractable domain, and there may be no guarantee that the measurement region overlaps with the predictable zone. As a result, the ensemble Kalman filter 106b and/or the phase-resolved nonlinear wave model 106a may apply a modified analysis equation (e.g., relative to equations (13)-(15)), in order to adjust the resulting phase-resolved ocean wave forecast based on the interplay among the predictable zone, the unpredictable zone, and the measurement region. For example, the modified analysis equations may include:

$${S}_{a , j}^{P} = {S}_{f , j}^{P} + {K}_{s , j}^{P} [ {S}_{m , j}^{P} - {G}_{j}^{P} {S}_{f , j}^{P} ] , \qquad ( 21 )$$

$${S}_{a , j}^{U} = {H}_{j} {S}_{m , j} , \qquad ( 22 )$$

where S may generally represent the collective ensemble indicated in equation (9), K_{s,j}^{P}=K_{s,j}(1:L^{P}, 1:d^{P}) and G_{s,j}^{P}, G_{s,j}(1:d^{P}, 1:L^{P}) may be sub-matrices of K_{s,j} and G_{s,j}, respectively, associated with x∈Pⱼ in both measurement and forecast spaces. Moreover, Hⱼ may be a linear operator which maps a state vector from measurement space to an unpredictable zone in the analysis space (e.g., [symbol] ^{d}→ [symbol] ^{L}^{^{U}}) based on linear/Fourier interpolation. Utilizing equations (21) and (22), the ensemble Kalman filter 106b and/or the phase-resolved nonlinear wave model 106a may achieve a minimized analysis error when analyzing the interplay among the predictable zone, the unpredictable zone, and the measurement region.

When the forecasting engine 106 generates the phase-resolved ocean wave forecast, the engine 106 may analyze and/or otherwise interpret the forecast to identify a rogue wave or other obstacle in the travel path of the vessel. In this situation, a modified route planner (e.g., modified route planner 106c) may generate a modified travel route in order for the vessel to avoid the rogue wave. Generally, the modified route planner 106c may consider a vessel (e.g., central ship 101) as a point mass moving in a two-dimensional plane subject to an evolving ocean wave field, as indicated by the phase-resolved ocean wave forecast. Moreover, the modified route planner 106c may consider that dangerous waves (e.g., rogue waves of sufficient height) may be treated as moving and deforming obstacles with known locations (e.g., for a future time). For ease of discussion, the modified route planner 106c may not constrain route planning based on the maneuverability of the vessel (such that sudden accelerations and turns are possible), other than an upper bound on the vessel speed.

For example, FIG. 3A illustrates an example route planning problem scenario 300 that the modified route planner 106c may analyze. The vessel may initially be located at a starting point 302, and the vessel may be traveling in order to reach the end point 304. Each of the dangerous obstacles 306a, 306b may be considered moving and deformable. As an example, the dangerous obstacles 306a, 306b may each be dangerous waves that are moving across the ocean surface with sufficient speed and/or height to damage and/or otherwise disrupt the travel of the vessel. The objective of the modified route planner 106c, when presented with the example route planning problem scenario 300, may be to determine the optimal path 308 by minimizing the time taken to traverse the distance between the starting point 302 and the end point 304 at least while avoiding each of the dangerous obstacles 306a, 306b during the entire duration of the travel from the starting point 302 to the end point 304. Further, the modified route planner 106c may utilize the vessel speed and heading 310 when making this determination, wherein the trajectory and velocity of the vessel may be characterized by:

$$P ( 0 ) = {x}_{s} , P ( {t}_{f} ) = {x}_{f} , \qquad ( 23 )$$

$$\dot{P} ( τ ) = F ( τ ) \cdot h ( τ ) , \qquad ( 24 )$$

$$with 0 \leq F ( τ ) \leq {F}_{max} , \qquad ( 25 )$$

Where xₛ is the starting point (e.g., starting point 302), x_{f} is the end point (e.g., end point 304), F(τ) is the velocity magnitude, h(τ) is a unit vector in the direction of travel of the vessel, equation (23) represents the trajectory of the vessel, and equation (24) represents the velocity of the vessel. As such, modified route planner 106c may find:

$${t}_{f}^{*} = \begin{matrix}min \\ F ( τ ) , h ( τ ) , τ ∈ [ 0 , {t}_{f} ]\end{matrix} \{ {t}_{f} \} , \qquad ( 26 )$$

Based on the previously mentioned constraints as well as the optimal path P*(τ) resulting from the optimal control F*(τ) and h*(τ).

More specifically, the modified route planner 106c may utilize reachability theory in order to generate modified travel routes that avoid dangerous obstacles. The modified route planner 106c may accordingly compute a forward reachable set corresponding to the vessel at any given time, in order to begin determining a modified travel route. For example, and as illustrated in the example route planning scenario 340 of FIG. 3B, a vessel 342 that may encounter a dangerous obstacle 344 may be able to reach any of the points on the ocean surface included within the forward reachable set 345. This may be formalized as:

$${R}_{0} [ t ] = \{ x ∈ {ℝ}^{2} \vert x = P ( t ) , ∃ F ( τ ) , h ( τ ) satisfying \\ equations ( 24 ) and ( 25 ) , such that : i ) P ( τ ) ∉ {A}_{o b s t} ( τ ) , ii ) P ( 0 ) = {x}_{s} \} , \qquad ( 27 )$$

thereby indicating that, for any position in the forward reachable set 345, there must exist admissible control inputs F(τ), h(τ) (τ∈[0, t]) that provide at least one obstacle-free trajectory (e.g., trajectories 346a, 348a, 350a, 352a) that connects the starting point (e.g., represented by the vessel 342) to the position (e.g., end points 346b, 348b, 350b, 352b) within the forward reachable set 345. In fact, the forward reachable front 354 may represent the “farthest” set that ca be reached by the vessel at a particular time t.

Utilizing equation (27), the modified route planner 106c may then determine the optimal time t_{f}* from equation (26) as the time when ∂R₀[t] first reaches the end point (e.g., end point 304). The modified route planner 106c may accordingly determine an optimal path P*(t) which remains on ∂R₀[t]. More specifically, the modified route planner 106c may perform two general actions in order to generate the optimal path: 1) forward propagation of R₀[t] until ∂R₀[t] reaches the end point at the optimal time; 2) backtracking to find intermediate waypoints on ∂R₀[t] as the optimal path. Of course, it should be appreciated that the modified route planner 106c may perform any suitable number of actions in order to generate a modified travel route.

Generally, the forward propagation implemented by the modified route planner 106c may include a representation of ∂R₀[t] through the level set function ϕ(x, t), which is then numerically incorporated by the modified route planner 106c. Namely, ∂R₀[t] may be implicitly embedded into the zero level set of the level set function as:

$$\partial {R}_{0} [ t ] ≡ \{ x ∈ {ℝ}^{2} \vert ϕ ( x , t ) = 0 \} , \qquad ( 28 )$$

where the evolution of ϕ(x, t) allows the modified route planner 106c to determine ∂R₀[t] during t∈[0, t_{f}*]. The modified route planner 106c may also utilize a value function ϕ(x, t) that can be defined for cases without obstacles as:

$$ϕ ( x , t ) ≡ \begin{matrix}Inf \\ F ( τ ) , h ( τ )\end{matrix} \{ J ( x , t , F ( τ ) , h ( τ ) ) \} , \qquad ( 29 )$$

where the cost functional J is non-positive if the start point of the trajectory is the start point (e.g., starting point 302, 342) and is positive if the start point of the trajectory is not the start point. Thus, the modified route planner 106c may utilize a governing equation for ϕ(x, t) for cases without obstacles that may be derived, for example, using dynamic programming to arrive at the Hamilton-Jacobi-Bellman (HJB) equation:

$$\frac{\partial ϕ ( x , t )}{\partial t} + \vert ∇ ϕ ( x , t ) \vert \cdot {F}_{max} = 0 , \qquad ( 30 )$$

with initial conditions ϕ(x, 0)=l(x), where l(x) represents a Lipchitz continuous function.

For cases where obstacles are present (e.g., example route planning scenario 340), the modified route planner 106c may account for the effects of such obstacles in several ways. For example, the modified route planner 106c may include a value function g(x, t) to represent the locations of obstacles by:

$$x ∈ {A}_{o b s t} ( t ) ↔ g ( x , t ) \geq 0 , \qquad ( 31 )$$

where g(x, t)=0 may represent the boundaries of the obstacles. Thus, the modified route planner 106c may utilize a value function that incorporates g(x, t) as:

$$ϕ ( x , t ) ≡ \begin{matrix}Inf \\ F ( τ ) , h ( τ )\end{matrix} \{ max ( l ( P ) , \begin{matrix}max \\ τ ∈ [ 0 , t ]\end{matrix} g ( P ( τ ) , τ ) ) \} , \qquad ( 32 )$$

where the term associated with g serves as a penalization due to obstacles. As a result, the governing equation for ϕ(x, t) is not the HJB equation (30), but is instead:

$$min \{ \frac{\partial ϕ ( x , t )}{\partial t} + \vert ∇ ϕ ( x , t ) \vert \cdot {F}_{max} , ϕ ( x , t ) - g ( x , t ) \} = 0 , \qquad ( 33 )$$

where

$$\frac{\partial ϕ ( x , t )}{\partial t} + \vert ∇ ϕ ( x , t ) \vert \cdot {F}_{max}$$

may be referenced herein as “term 1”, ϕ(x, t)−g(x, t) may be referenced herein as “term 2”, and with the initial condition

ϕ(x,0)=max{l(x),g(x,0)} (34).

Accordingly, when x∈∂R₀[t], the modified route planner 106c may either solve the HJB equation (30) or assign g(x, t) to ϕ(x, t).

In order to solve equation (33) with equation (34), the modified route planner 106c may utilize a prediction-correction scheme that steps equation (29) through time. Namely, the prediction-correction scheme may include a prediction step that itself includes evolving term 1=0 from tₙ to tₙ₊₁ by a numerical scheme, for example:

\hat{ϕ}(x,tₙ₊₁)=F(ϕ(x,tₙ),g(x,tₙ)) (35),

where F is an operator that solves term 1=0 based on the specific numerical scheme applied by the modified route planner 106c. The prediction-correction scheme implemented by the modified route planner 106c may also perform a correction step that includes assigning a maximum between \hat{ϕ}(x, tₙ₊₁) and g(x, tₙ₊₁) to ϕ(x, tₙ₊₁), represented as:

$$ϕ ( x , {t}_{n + 1} ) = max ( \hat{ϕ} ( x , {t}_{n + 1} ) , g ( x , {t}_{n + 1} ) ) , \qquad ( 36 )$$

Generally, the modified route planner 106c may solve equations (35) and (36) until ϕ(x_{f}, t)=0, such that ∂R₀[t] first reaches an end point with the value of t corresponding to t_{f}*. For certain complicated wave fields, ϕ(x, t) may be distorted significantly (e.g. with a sharp gradient), and as a result, the modified route planner 106c may re-initialize ϕ(x, t) periodically, for example, using a partial differential equations-based method, as a signed distance function while keeping ∂R₀[t] the same.

When ∂R₀[t] is obtained from the forward propagation, the modified route planner 106c may perform backtracking to identify the intermediate waypoints of the optimal path. Backtracking generally involves the modified route planner 106c tracking a path from the end point backwards with F*(τ) and h*(τ) until the planner 106c reaches the starting point. For instances where no obstacle is present, the intermediate waypoints may be analytically obtained by the modified route planner 106c using the following:

$$\{ \begin{matrix}{h}^{*} ( τ ) = \frac{∇ ϕ ( {P}^{*} ( τ ) , τ )}{\vert ∇ ϕ ( {P}^{*} ( τ ) , τ ) \vert} \\ {F}^{*} ( τ ) = {F}_{max}\end{matrix} , \qquad ( 37 )$$

and the planner 106c may extend equation (37) to instances where an obstacle with a known velocity is present. In order to backtrack in instances where deforming obstacles are present and/or multiple optimal paths exist, the modified route planner 106c may utilize a backward reachable set B₀ [−t], which may represent the set of initial states that can reach a target set at the end of [−t,0]. Generally, the modified route planner 106c may compute B₀[−t] by solving equation (29) backward in time, and the planner 106c may construct the backward reachable set using

$$\frac{C}{{A}_{o b s t}} ,$$

where C represents a circular area of radius Fₘₐₓ·Δt.

More specifically, the modified route planner 106c may begin backtracking by determining one or more intersections between ∂R₀[tₙ₋₁] and B₀[−Δt] as the previous waypoints for one or more paths at a particular end point. The modified route planner 106c may thereby generate an optimal path/route for each end point by determining all possible paths that reach the starting point while simultaneously satisfying the conditions specified herein. In this manner, the modified route planner 106c may generate modified travel routes for vessels based on the obstacles present within the scannable region of the vessel (e.g., 103) and/or combined scannable region of one or more additional vessels, structures, and/or other objects, that maximize the energy efficiency (e.g., fuel consumption) of vessels by minimizing total travel distance while simultaneously minimizing the risk associated with a respective vessel's travel to a destination by avoiding all obstacles (e.g., rogue waves).

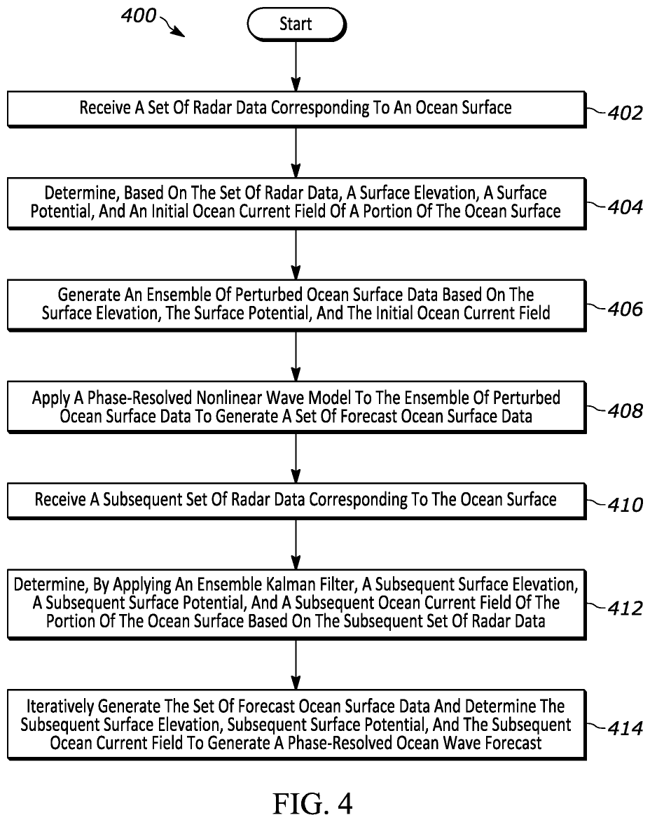

FIG. 4 illustrates an example method 400 for generating a phase-resolved ocean wave forecast with simultaneous ocean current estimation using data assimilation, in accordance various aspects disclosed herein. For ease of discussion, many of the various actions included in the method 400 may be described herein as performed by or with the use of a forecasting engine (e.g., forecasting engine 106). However, it is to be appreciated that the various actions included in the method 400 may be performed by, for example, a local processor (e.g., processor 122) executing the forecasting engine, an external server, and/or other suitable processors or combinations thereof.

The example method 400 may include (a) receiving, at one or more processors, a set of radar data corresponding to an ocean surface (block 402). The example method 400 may also include (b) determining, by the one or more processors based on the set of radar data, a surface elevation, a surface potential, and an initial ocean current field of a portion of the ocean surface (block 404). The example method 400 may also include (c) generating, by the one or more processors, an ensemble of perturbed ocean surface data based on the surface elevation, the surface potential, and the initial ocean current field (block 406).

The example method 400 may also include (d) applying, by the one or more processors, a phase-resolved nonlinear wave model to the ensemble of perturbed ocean surface data to generate a set of forecast ocean surface data (block 408). The example method 400 may also include (e) receiving, at the one or more processors, a subsequent set of radar data corresponding to the ocean surface (block 410). The example method 400 may also include (f) determining, by the one or more processors applying an ensemble Kalman filter, a subsequent surface elevation, a subsequent surface potential, and a subsequent ocean current field of the portion of the ocean surface based on the subsequent set of radar data (block 412).

The example method 400 may also include (g) iteratively performing, by the one or more processors, steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data. In some embodiments, the example method 400 may further include identifying, by the one or more processors, a rogue wave based on the phase-resolved ocean wave forecast; and generating, by the one or more processors applying a modified route planner, a modified travel route for a ship to avoid the rogue wave.

In certain embodiments, the example method 400 may further include iteratively performing, by the one or more processors, steps (e)-(g) for the portion of the ocean surface until the portion is not included in the subsequent set of radar data.

In some embodiments, the set of radar data includes radar data corresponding to a plurality of points across a region of the ocean surface, and the portion of the ocean surface corresponds to a respective point of the plurality of points. Further in these embodiments, the example method 400 may further include performing, by the one or more processors, steps (b)-(g) for each respective point of the plurality of points.

In certain embodiments, the example method 400 may further include linearly inflating, by the one or more processors utilizing an adaptive inflation algorithm, the set of forecast ocean surface data.

In some embodiments, the example method 400 may further include identifying, by the one or more processors, a first predictable zone and a first unpredictable zone within the set of radar data; identifying, by the one or more processors, a second predictable zone and a second unpredictable zone within the subsequent set of radar data; and iteratively performing steps (d) and (f) to generate the phase-resolved ocean wave forecast based on radar data from the set of radar data corresponding to an overlap region between the first predictable zone and the second predictable zone.

In certain embodiments, the phase-resolved nonlinear model may include a high-order spectral (HOS) method.

In some embodiments, the ensemble of perturbed ocean surface data includes a plurality of surface elevations, a plurality of surface potentials, and a plurality of initial ocean currents. Further in these embodiments, the example method 400 may further include generating, by the one or more processors utilizing a set of measurement error statistics, the ensemble of perturbed ocean surface data based on the plurality of surface elevations, the plurality of surface potentials, and the plurality of initial ocean currents.

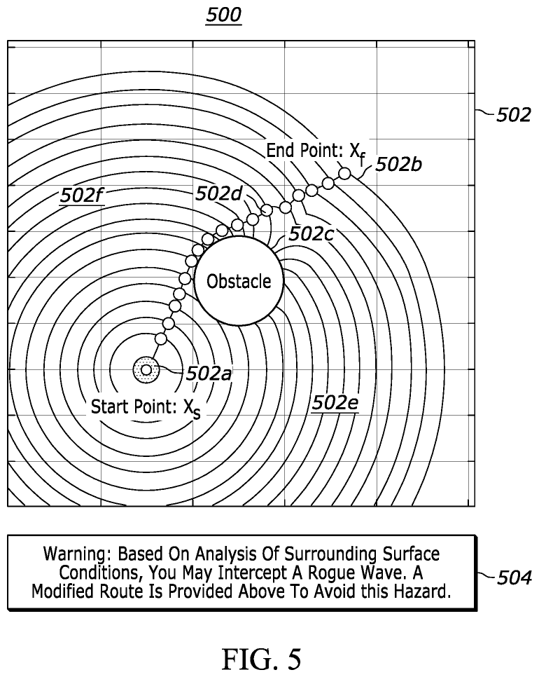

Moreover, in certain aspects, the example method 400 may also include causing, by the one or more processors, a user device to display the phase-resolved ocean wave forecast and/or the ocean current field on a user interface of the user device for viewing by a user. For example, FIG. 5 depicts an example user interface display 500 enabling a user to view a modified travel route to avoid an identified obstacle, in accordance with various aspects disclosed herein. In particular, as illustrated in FIG. 5, the user device (e.g., on-board radar system 102, example system 120) may render a display that includes a graphical display portion 502 and a textual display portion 504.

The graphical display portion 502 may include the current location 502 of the vessel, the destination 502b of the vessel, the obstacle 502c, and the modified travel route 502d. The modified travel route 502d may be indicated as a series of waypoints along the route (as illustrated in FIG. 5) and/or may be a continuous line, or any other suitable representation of a route or combinations thereof. In certain aspects, the graphical display portion 502 may additionally include multiple modified travel routes indicating alternative travel routes that avoid the obstacle 502c while traveling from the current location 502a to the destination 502b. As such, each alternative travel route displayed on the graphical display portion 502 may provide a user with a selectable option between/among the alternative modified travel routes. For example, a user may desire to take a different modified route to avoid the obstacle than the modified route suggested by the system (e.g., example system 120). Thus, the user may interact with the graphical display portion 502 and/or corresponding input components (e.g., I/O components 124b) to select the different modified route.

Each of the objects represented on the graphical display portion 502 may be and/or otherwise include any suitable type of text, symbols, patterns, colors, and/or any other suitable visual indicia. For example, as illustrated in FIG. 5, the current location 502 is marked with text reading “Start Point: X_{S}”, the destination 502b is marked with text reading “End Point: X_{f}”, and the obstacle 502c is marked with text reading “Obstacle”. Moreover, each object represented on the graphical display portion 502 may be or include an image, video, and/or any other suitable visual display configuration.

Further, in certain embodiments, the graphical display portion 502 may include indications 502e, 502f of the ocean current field determined as a result of the forecasting engine 106 generating the phase-resolved ocean wave forecast. The indications 502e, 502f may be or include graphical relative strength indicators (e.g., colors, symbols, graphics, etc.) of ocean currents at the indicated locations, numerical representations of the current strength at the indication locations, textual strength indicators (e.g., “strong”, “weak”, etc.), and/or any other suitable indicator types or combinations thereof.

Of course, it should be appreciated that the indications 502e, 502f depicted in FIG. 5 are illustrated as singular indications for the purposes of discussion only. The graphical display portion 502 may include any suitable number of indications 502e, 502f, that may be of any suitable size. For example, in certain embodiments, the indications 502e, 502f may be part of a graphical overlay that represents the forecast ocean current field at a plurality of locations across the graphical display portion 502. This graphical overlay may include, for example, multiple lines extending across the graphical display portion 502 that have arrowheads (and/or other graphics) disposed thereon to indicate the relative direction, strength, and/or any other suitable metric of the ocean current at the corresponding location.

The textual display portion 504 may include a text-based message for a user that corresponds to the display within the graphical display portion 502. For example, as illustrated in FIG. 5, the textual display portion 504 includes text reading “Based on analysis of surrounding surface conditions, you may intercept a rogue wave. A modified route is provided above to avoid this hazard.” Thus, the text-based message within the textual display portion 504 may enable a user to understand the context of the display within the graphical display portion 502, and as a result, the user may make more informed decisions to follow the modified route, thereby alleviating risk to the vessel from contact with the obstacle 502c and wasteful energy consumption during avoidance of the obstacle 502c.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “one aspect,” “an aspect,” or “an embodiment” means that a particular element, feature, structure, or characteristic described in connection with the embodiment is included in at least one embodiment/aspect. The appearances of the phrase “in one embodiment” or “in one aspect” in various places in the specification are not necessarily all referring to the same embodiment/aspect.

Some embodiments/aspects may be described using the expression “coupled” and “connected” along with their derivatives. For example, some embodiments/aspects may be described using the term “coupled” to indicate that two or more elements are in direct physical or electrical contact. The term “coupled,” however, may also mean that two or more elements are not in direct contact with each other, but yet still co-operate or interact with each other. The embodiments/aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/aspects herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments/aspects without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. A method for generating a phase-resolved ocean wave forecast with simultaneous ocean current estimation using data assimilation, the method comprising:
(a) receiving, at one or more processors, a set of radar data corresponding to an ocean surface;
(b) determining, by the one or more processors based on the set of radar data, a surface elevation, a surface potential, and an initial ocean current field of a portion of the ocean surface;
(c) generating, by the one or more processors, an ensemble of perturbed ocean surface data based on the surface elevation, the surface potential, and the initial ocean current field;
(d) applying, by the one or more processors, a phase-resolved nonlinear wave model to the ensemble of perturbed ocean surface data to generate a set of forecast ocean surface data;
(e) receiving, at the one or more processors, a subsequent set of radar data corresponding to the ocean surface;
(f) determining, by the one or more processors applying an ensemble Kalman filter, a subsequent surface elevation, a subsequent surface potential, and a subsequent ocean current field of the portion of the ocean surface based on the subsequent set of radar data; and
(g) iteratively performing, by the one or more processors, steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

2. The method of claim 1, further comprising:
identifying, by the one or more processors, a rogue wave based on the phase-resolved ocean wave forecast; and
generating, by the one or more processors applying a modified route planner, a modified travel route for a ship to avoid the rogue wave.

3. The method of claim 1, wherein the method further comprises:
iteratively performing, by the one or more processors, steps (e)-(g) for the portion of the ocean surface until the portion is not included in the subsequent set of radar data.

4. The method of claim 1, wherein the set of radar data includes radar data corresponding to a plurality of points across a region of the ocean surface, the portion of the ocean surface corresponds to a respective point of the plurality of points, and wherein the method further comprises:
performing, by the one or more processors, steps (b)-(g) for each respective point of the plurality of points.

5. The method of claim 1, further comprising:
linearly inflating, by the one or more processors utilizing an adaptive inflation algorithm, the set of forecast ocean surface data.

6. The method of claim 1, further comprising:
identifying, by the one or more processors, a first predictable zone and a first unpredictable zone within the set of radar data;
identifying, by the one or more processors, a second predictable zone and a second unpredictable zone within the subsequent set of radar data; and
iteratively performing steps (d) and (f) to generate the phase-resolved ocean wave forecast based on radar data from the set of radar data corresponding to an overlap region between the first predictable zone and the second predictable zone.

7. The method of claim 1, wherein the phase-resolved nonlinear model comprises a high-order spectral (HOS) method.

8. The method of claim 1, wherein the ensemble of perturbed ocean surface data includes a plurality of surface elevations, a plurality of surface potentials, and a plurality of initial ocean currents, and the method further comprises:
generating, by the one or more processors utilizing a set of measurement error statistics, the ensemble of perturbed ocean surface data based on the plurality of surface elevations, the plurality of surface potentials, and the plurality of initial ocean currents.

9. The method of claim 1, further comprising:
causing, by the one or more processors, a user device to display the phase-resolved ocean wave forecast and the subsequent ocean current field on a user interface of the user device for viewing by a user.

10. A system for generating a phase-resolved ocean wave forecast with simultaneous ocean current estimation using data assimilation, the system comprising:
a memory storing a set of computer-readable instructions comprising at least a phase-resolved nonlinear wave model and an ensemble Kalman filter; and
one or more processors interfacing with the memory, and configured to execute the set of computer-readable instructions to cause the one or more processors to:
(a) receive a set of radar data corresponding to an ocean surface,
(b) determine, based on the set of radar data, a surface elevation, a surface potential, and an initial ocean current field of a portion of the ocean surface,
(c) generate an ensemble of perturbed ocean surface data based on the surface elevation, the surface potential, and the initial ocean current field,
(d) apply a phase-resolved nonlinear wave model to the ensemble of perturbed ocean surface data to generate a set of forecast ocean surface data,
(e) receive a subsequent set of radar data corresponding to the ocean surface,
(f) determine, by applying an ensemble Kalman filter, a subsequent surface elevation, a subsequent surface potential, and a subsequent ocean current field of the portion of the ocean surface based on the subsequent set of radar data, and
(g) iteratively perform steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

11. The system of claim 10, wherein the set of computer-readable instructions further cause the one or more processors to:
identify a rogue wave based on the phase-resolved ocean wave forecast; and
apply a modified route planner to generate a modified travel route for a ship to avoid the rogue wave.

12. The system of claim 10, wherein the set of computer-readable instructions further cause the one or more processors to:
iteratively perform (e)-(g) for the portion of the ocean surface until the portion is not included in the subsequent set of radar data.

13. The system of claim 10, wherein the set of radar data includes radar data corresponding to a plurality of points across a region of the ocean surface, the portion of the ocean surface corresponds to a respective point of the plurality of points, and wherein the set of computer-readable instructions further cause the one or more processors to:
perform (b)-(g) for each respective point of the plurality of points.

14. The system of claim 10, wherein the set of radar data is collected by a plurality of ships and a plurality of buildings.

15. The system of claim 10, wherein the ensemble of perturbed ocean surface data includes a plurality of surface elevations, a plurality of surface potentials, and a plurality of initial ocean currents, and wherein the set of computer-readable instructions further cause the one or more processors to:
generate, by utilizing a set of measurement error statistics, the ensemble of perturbed ocean surface data based on the plurality of surface elevations, the plurality of surface potentials, and the plurality of initial ocean currents.

16. The system of claim 10, further comprising a user interface, and wherein the set of computer-readable instructions further cause the one or more processors to:
cause the user interface to display the phase-resolved ocean wave forecast and the subsequent ocean current field for viewing by a user.

17. A non-transitory computer-readable storage medium having stored thereon a set of instructions, executable by at least one processor, for generating a phase-resolved ocean wave forecast with simultaneous ocean current estimation using data assimilation, the instructions comprising:
(a) instructions for receiving a set of radar data corresponding to an ocean surface;
(b) instructions for determining, based on the set of radar data, a surface elevation, a surface potential, and an initial ocean current field of a portion of the ocean surface;
(c) instructions for generating an ensemble of perturbed ocean surface data based on the surface elevation, the surface potential, and the initial ocean current field;
(d) instructions for applying a phase-resolved nonlinear wave model to the ensemble of perturbed ocean surface data to generate a set of forecast ocean surface data;
(e) instructions for receiving a subsequent set of radar data corresponding to the ocean surface;
(f) instructions for determining, by applying an ensemble Kalman filter, a subsequent surface elevation, a subsequent surface potential, and a subsequent ocean current field of the portion of the ocean surface based on the subsequent set of radar data; and
(g) instructions for iteratively performing steps (d) and (f) to generate a phase-resolved ocean wave forecast, wherein steps (d) and (f) are iteratively performed until a tolerance factor satisfies a tolerance threshold, and each subsequent iteration of steps (d) and (f) utilizes the subsequent ocean current field to generate the set of forecast ocean surface data.

18. The non-transitory computer-readable storage medium of claim 17, wherein the instructions further comprise:
instructions for identifying a rogue wave based on the phase-resolved ocean wave forecast; and
instructions for applying a modified route planner to generate a modified travel route for a ship to avoid the rogue wave.

19. The non-transitory computer-readable storage medium of claim 17, wherein the instructions further comprise:
instructions for iteratively performing (e)-(g) for the portion of the ocean surface until the portion is not included in the subsequent set of radar data.

20. The non-transitory computer-readable storage medium of claim 17, wherein the set of radar data includes radar data corresponding to a plurality of points across a region of the ocean surface, the portion of the ocean surface corresponds to a respective point of the plurality of points, and wherein the instructions further comprise:
instructions for performing (b)-(g) for each respective point of the plurality of points.
